(19) United States
(12) Patent Application Publication
(10) Pub. No.: US 2008/0202349 A1
(43) Pub. Date: Aug. 28, 2008

(54) DEEP FRYING APPARATUS HAVING A ROTATING BASKET

(76) Inventor: ZHENG PENG, Ypsilanti, MI (US)

Correspondence Address: ZHAOXIA XU, 4694 SYCAMORE DR., YPSILANTI, MI, 48197, US

(21) Appl. No.: 11/678,938

(22) Filed: Feb. 26, 2007

(51) Int. Cl. A47J 37/12

(52) U.S. Cl. 99/329 R; 99/409

(57) ABSTRACT

A deep-frying apparatus (100). Deep frying apparatus (100) comprises a container (102) having an open top and a sidewall for holding food, a lid (104) for closing the open top of container (102), a perforated basket (114) installed inside container (102) for holding and rotating food, a co-rotation prevention member (118) installed inside container (102) on the sidewall for generating favorable oil flow, as basket (114) rotates, a heating tube (116) fixedly installed on the bottom of container (102) for heating food, a base support (112) disposed underneath container (102) for supporting container (102), a support member (110) installed on the bottom of container (102) for adapting container (102) to stand in position on base support (112), and a motor (124) installed inside base support (112) and coupled with basket (114) for driving basket (114).

### TECHNICAL FIELD AND INDUSTRIAL APPLICABILITY OF THE INVENTION

This invention generally relates to cooking apparatuses or equipment. More specifically, this invention relates to deep-frying apparatuses having a rotating basket.

### BACKGROUND OF THE INVENTION

Fried foods, such as fried shrimp, fried fish, fried chicken, etc., are tasteful. Two of the most important characteristics of fried foods are: outside, golden and crispy; and inside, juicy and tender.

Traditional deep fryers have a container sitting on a heater and a handle for use of handling the container. When deep-frying food, people have to stir or turn over food to facilitate heat transfer and uniform heating, especially when deep-frying battered food; which requires skill and labor.

Many products of deep-frying apparatuses are on the market and many patents have been issued.

U.S. Pat. No. 6,365,878, issued to Lau, on Apr. 2, 2002, illustrates an electric frying apparatus, with which a vertically moving basket is equipped.

U.S. Pat. No. 5,027,697, issued to De Longhi, on Jul. 2, 1991, teaches regarding a rotating oblique basket fryer for cyclic immersion cooking; which facilitates the elimination of moisture in the food, accelerates the heat exchange process, and favors uniform operating temperatures.

U.S. Pat. No. 6,845,707, issued to Xu, et al., on Jan. 25, 2006, teaches regarding an automatic cooking apparatus having a basket installed inside an inner pan for automated stirring and cooking. The basket is not rotating; instead, the stirrer is rotating.

However, prior art products have a full housing in designs, resulting in being too bulky for kitchens and too expensive to manufacture. Market testing has shown that consumers desire a deep frying apparatus that is compact and simple enough to be less bulky to save kitchen space and to be less expensive to manufacture. In additions, it is highly advantageous to introduce oil flow within the frying pan white food is fried. Favorable oil flow would facilitate heat transfer to food and distribute temperature more uniformly within the frying pan.

Therefore, it remains desirable to provide a deep frying apparatus that is innovative in design, such that it is less bulky to save kitchen space and less expensive to manufacture, and that includes a basket that rotates during frying food, such that heat exchange is facilitated and the temperature is distributed more uniformly within the frying pan.

### BRIEF SUMMARY OF THE INVENTION

Accordingly, the present invention is a deep-frying apparatus. This deep frying apparatus comprises a container having an open top and a sidewall for holding food, a lid for closing up the open top of the container, a support member fixedly engaged with the lower portion of the container and extended downward to a predetermined distance for adapting the container to stand on a base support or a horizontal counter top, a perforated basket rotatably installed inside the container for holding and rotating food, a heating tube installed on the bottom of the container for heating food, a co-rotation prevention member installed on the sidewall of the container for generating a favorable oil flow, as the basket rotates, and a motor installed inside the base support and removably coupled with the basket for driving the basket.

Accordingly, the followings are some of the objects, features, and advantages of the present invention.

It is an object of the present invention to provide a deep frying apparatus that is simple to use, less bulky to save kitchen space, and less expensive to manufacture.

It is a feature of the present invention that this deep frying apparatus includes a rotating basket, which rotates food and generates a favorable oil flow within the pan during deep-frying. The rotating basket is removably installed inside the container and is equipped with a removable handle.

It is another feature of the present invention that this deep-frying apparatus includes a support member for supporting the container. The upper end of the support member is fixedly engaged with the periphery of the bottom portion of the container and the lower end of the support member extends downward to a predetermined distance for adapting the container to stand on a base support or on a horizontal surface. The container together with the support member is removable, such that the container is convenient to dean after use and dishwasher safe.

It is a furthermore feature of the present invention that the heating tube is fixedly installed on the bottom of the container to save some cost associated with a full heater having a thermal diffusion plate, which requires significant amount of material and space. By directly installing the heating tube on the bottom of the container heating efficiency is significantly enhanced.

It is a still furthermore feature of the present invention that the container is not enclosed inside a housing, such that some cost and space associated with a full housing is saved, compared with prior art products.

It is an advantage of the present invention that the deep-frying apparatus is highly compact in design to save space and material cost.

Further more features and advantages of the present invention wilt be readily appreciated; as the same becomes better understood after reading the subsequent description when considered in connection with the non-limiting accompanying drawings.

### BRIEF DESCRIPTION OF THE DRAWINGS

FIG. 1 illustrates a cross-sectional view of an embodiment of the present inventions a deep frying apparatus 100.

FIG. 2 illustrates a perspective view of basket 114.

FIG. 3 illustrates a bottom view of container 102.

FIG. 4 illustrates a top view of base support 112.

FIG. 5 illustrates an exploded cross-sectional view of seal device 130 and coupling device 132.

FIG. 6 illustrates another cross-sectional view of deep frying apparatus 100.

FIG. 7 illustrates a cross-sectional view of another embodiment of the present invention, a deep frying apparatus 200.

FIG. 8 illustrates a side view of coupling device 208 for deep frying apparatus 200.

FIG. 9 illustrates a top view of coupling device 208 for deep frying apparatus 200.

### DETAILED DESCRIPTION OF THE INVENTION

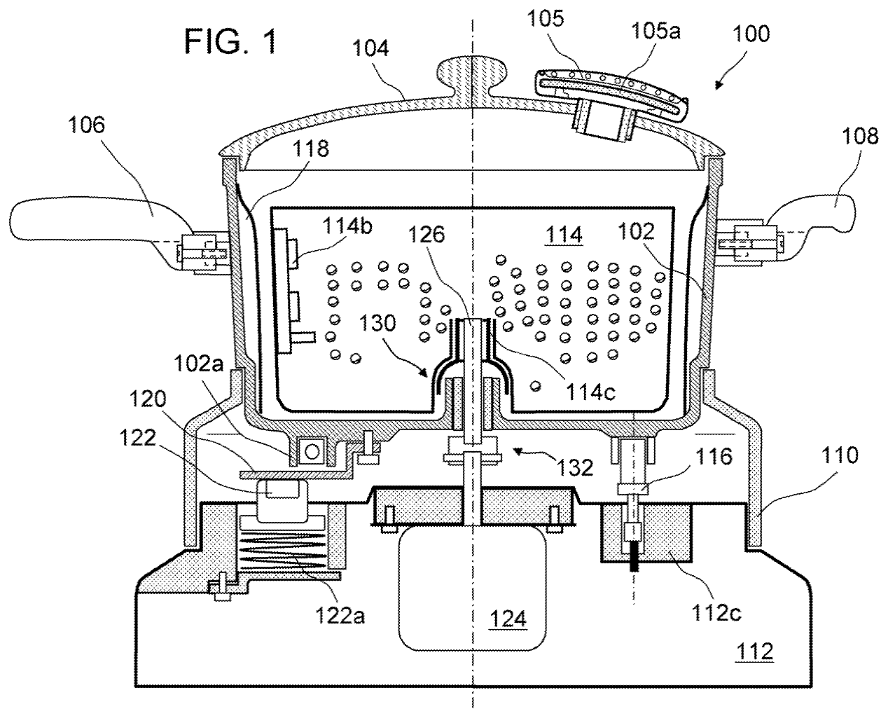

Reference is made to FIG. 1, which illustrates a cross-sectional view of an embodiment of the present invention, a deep frying apparatus 100.

A container 102, having an open top, a sidewalk and a central aperture on the bottom, is provided for holding food. The sidewall of container 102 is slightly tapered with a larger diameter on the top and a smaller diameter on the bottom. Container 102 is, preferably, coated with a non-stick material.

A lid 104 is provided for closing up the open top of container 102. Lid 104 is, preferably, made of a transparent material.

A venting device 105, removably installed on lid 104, is provided for exhausting cooking fumes. A filtering pad 105a, e.g., a sponge-like, or fabric, or activated carbon filtering pad, is provided for removing the grease content within the grease-laden cooking fumes for home environment protection.

A grasp handle 106 and a lift handle 108 are fixedly installed on the upper portion of the sidewall of container 102 for use of handling container 102.

A support member 110, having a generally tapered hollow cylindrical configuration, is provided for supporting container 102. The upper end of support member 110 is fixedly engaged with the periphery of the bottom portion of container 102 and the lower end of support member 110 is extended downward to a predetermined distance, such that container 102 is adapted to stand on a base support 112 or on a horizontal countertop. Support member 110 is provided also for enclosing the space underneath the bottom of container 102 into a protected space. Some windows or slots may be opened on support member 110 for venting heat, etc. Support member 110 is, preferably, made of a non-metal material of low thermal conductivity, such that container 102 together with support member 110 can directly stand on a counter top or a dinning table without the risk of overheating the same.

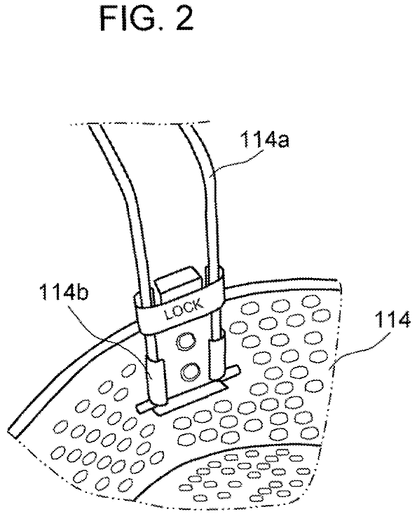

A perforated basket 114, removably and rotatably installed inside container 102, is provided for holding and rotating food, such as French fries, chicken nuggets, fish sticks, etc. There is a predetermined clearance between the bottom of basket 114 and the bottom of container 102 to avoid scratching between the two bottoms, as basket 114 rotates. Basket 114 rotates while deep-frying food, such that the food is rotated and the oil within container 102 is forced to move with respect to food, such that heat transfer is facilitated to save time and energy. Basket 114 includes a removable handle 114a. When basket 114 is installed inside container 102, handle 114a can be removed, as shown in FIG. 2, which illustrates a perspective view of basket 114. Handle 114a can be lockably engaged with a coupling base 114b that is fixedly installed on the side of basket 114 when used for handling basket 114.

An electrical heating tube 116, having a generally circular configuration, is provided for heating food disposed inside container 102. Heating tube 116 is fixedly installed on the outside of the bottom of container 102, inserted into a groove 102a formed on the bottom of container 102, and disposed close to the periphery with a predetermined distance. The two electrical terminals of heating tube 116 are extended downward to a predetermined distance and are adapted to removably engage with an electrical power supply, as container 102 is installed in position on base support 112. There are significant advantages of installing heating tube 116 directly on the bottom of container 102. These advantages include saving a significant amount of material for building a full heater that has a thermal diffusion plate, resulting in space and cost saving and higher heat transfer efficiency.

A plurality of co-rotation prevention members 118 is integrally constructed inside container 102, on the sidewall, for preventing hot oil from co-rotating with basket 114, as basket 114 rotates. Members 118 include a rib-shaped elongated member that extends generally vertical along the sidewall of container 102. The upper ends of members 118 extend substantially to the upper portion of container 102. Members 118 are preferably disposed substantially close to handles 106 or 108, such that members 118 would not obstruct food unloading. Members 118 extend inward to a predetermined distance, away from the sidewall of container 102. The predetermined distance is determined based on the size of container 102. Proper clearance between members 118 and basket 114 should be maintained. When oil co-rotates with basket 114 and runs against members 118, as basket 114 rotates, the oil flow direction is diverted by member 118, resulting in favorable oil flow with respect to food, thereby facilitating heat transfer to and uniform heating of food.

A thermo plate 120, made of a material of high thermal conductivity, is fixedly installed on the bottom of container 102, at a location substantially close to heating tube 116, for removably engaging a thermostat 122. Thermostat 122 is installed on base support 112 and engaged with thermo plate 120 for detecting the temperature, as container 102 is installed in position on base support 112. Such temperature is used to control the electrical power to heating tube 116. The upper end of thermostat 122 protrudes upward above the upper surface of base support 112 with a pre-loading, e.g., via a spring member 122a. Thermostat 122 can be a digital sensor, such as a NTC or PTC, or an adjustable thermostat, or simply a temperature switch, as known to those skilled in the art.

Base Support 112, disposed underneath container 102, is provided for supporting container 102. The upper portion of base support 112 is removably engaged with the inner periphery of the lower portion of support member 110. As container 102 is installed in position on base support 112, thermostat 122 is engaged with thermo plate 120, or directly with the bottom of container 102, and the electrical terminals of heating tube 116 are removably connected with an electrical port 112c on base support 112 for electrical supply.

A motor 124 is installed inside base support 112 for providing rotation power to basket 114. Motor 124 is removablely coupled with a drive shaft 126, as container 102 is installed in position. Drive shaft 126 is threaded through the central aperture on the bottom of container 102. The upper end of shaft 126 is removably engaged with basket 114 through a basket coupling element 114c for supporting and rotating basket 114 and the lower end of shaft 126 is coupled with motor 124 through a Coupling device 132. A seal device 130 is provided for sealing off the interface between shaft 126 and the bottom of container 102.

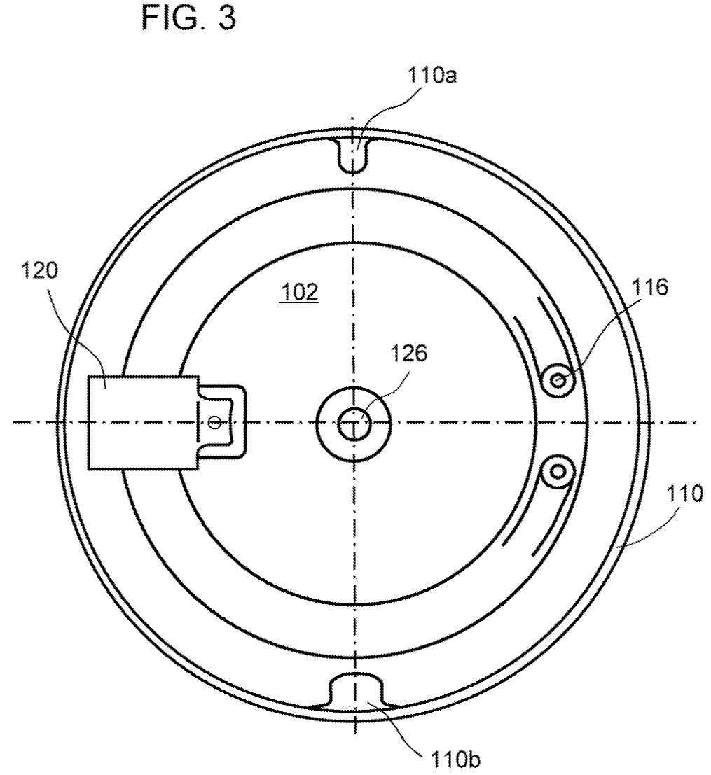

FIG. 3 illustrates a bottom view of container 102 to depict the general layout of various components disposed on the bottom of container 102. Two position guides, generally designated as 110a and 110b, protrude inward a predetermined distance from the inner surface of support member 110 for guiding container 102 in position on base support 112.

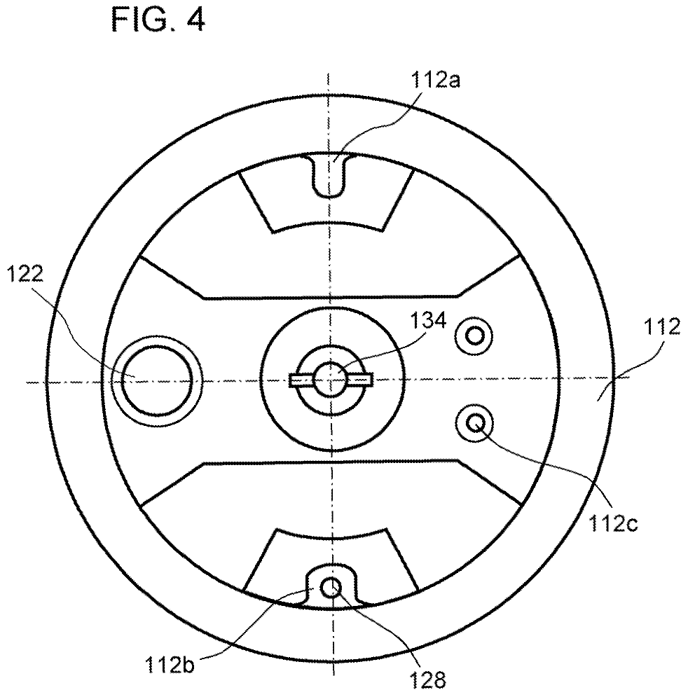

FIG. 4 illustrates a top view of base support 112 to depict the general layout of various components disposed on the top of base support 112. Two base guides, generally designated as 112a and 112b, are provided for removably receiving position guides 110a and 110b, respectively. Electrical port 112c is disposed on top of base support 112 for removably receiving the electrical terminals from heating tube 116, such that electrical power from base support 112 is provided to heating tube 116, as container 102 is installed in position on base support 112. An in-position detector 128 is installed on base support 112 for detecting whether container 102 is properly installed or not. Detector 128 is disposed at the bottom of base guide 112b. The upper end of detector 128 protrudes a predetermined distance above the bottom of guide 112b, such that when container 102 is installed in position on base support 112, the lower end of position guide 110b would press with a force on detector 128 to confirm that container 102 is well positioned.

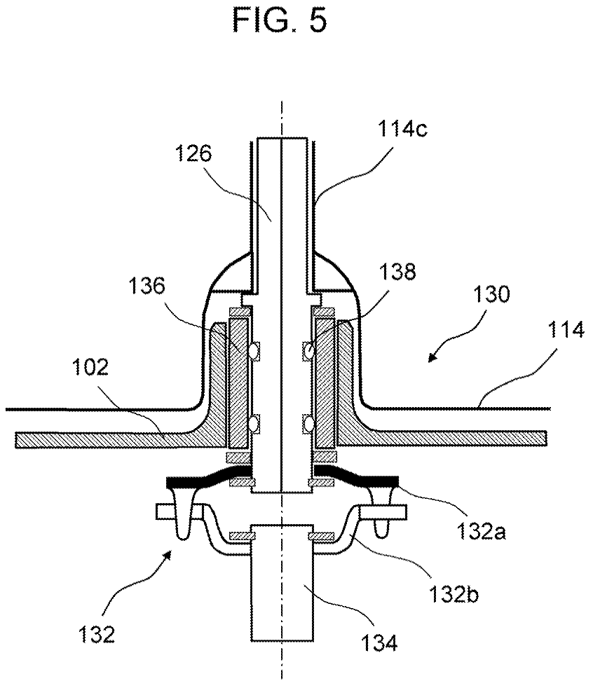

FIG. 5 illustrates an exploded cross-sectional view of seal device 130 and coupling device 132. Seal device 130 comprises a bushing member 136 and a packing member 138. Coupling device 132 includes an upper coupling element 132a, which is engaged with the lower end of shaft 126, and a lower coupling element 132b, which is engaged with a motor shaft 134.

Bushing 136 is co-axial to shaft 126 and is fixedly and sealingly engaged with the bottom of container 102. Packing 138 is inserted into a groove cut around shaft 126. A plurality of packing 138 can be provided for more reliable sealing as known to those skilled in the art. When inserted into bushing 136 together with shaft 126, packing 138 is compressed and squeezed against shaft 126 and bushing 136 to seal off the interface thereof. Bushing 136 extends upward to a predetermined height above the bottom of container 102, such that the upper end of bushing 136 and packing 138 are disposed above the bottom of container 102 and such that the requirement on seal device 130 is significantly reduced. The clearance between bushing 136 and shaft 126 is minimized for ideal sealing performance, but, shaft 126 should be able to rotate with minimal friction resistance, which requires high precision of the fitting surfaces thereof.

Materials for packing 138 are extremely important when selecting the proper packing for an application. Basic requirements include heat resistance, wearing resistance, elasticity, etc.

Seal device 130 can, alternatively, take many other forms, such as bushing, labyrinth, packing, or combinations of multiple forms for ideal performance, as known to those skilled in the art and suggested by this invention disclosure.

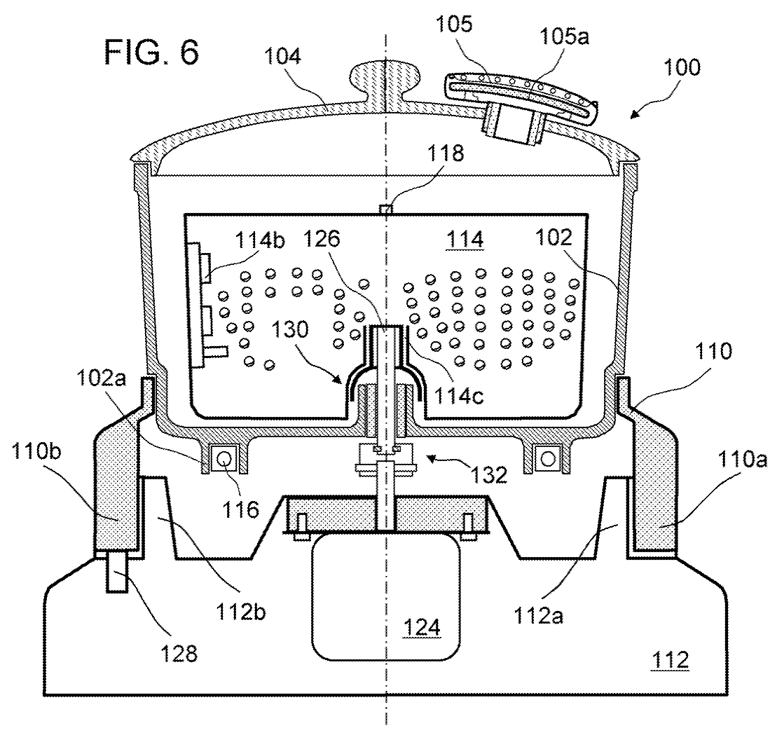

FIG. 6 illustrates another cross-sectional view of deep-frying apparatus 100 to better depict how container 102 is installed on base support 112. Position guides 110a and 110b are inserted into base guides 112a and 112b, respectively, such that container 102 is removably locked in position on base support 112.

Accordingly, as container 102 is properly installed in position on base support 112, thermostat 122 is engaged with thermo plate 120, or directly with the bottom of container 102, the electrical terminals of heating tube 116 are connected with electrical port 112c, motor 124 is coupled with shaft 126, and detector 128 is depressed to confirm that container 102 is well in position. Deep-frying apparatus 100 is, now, ready for cooking.

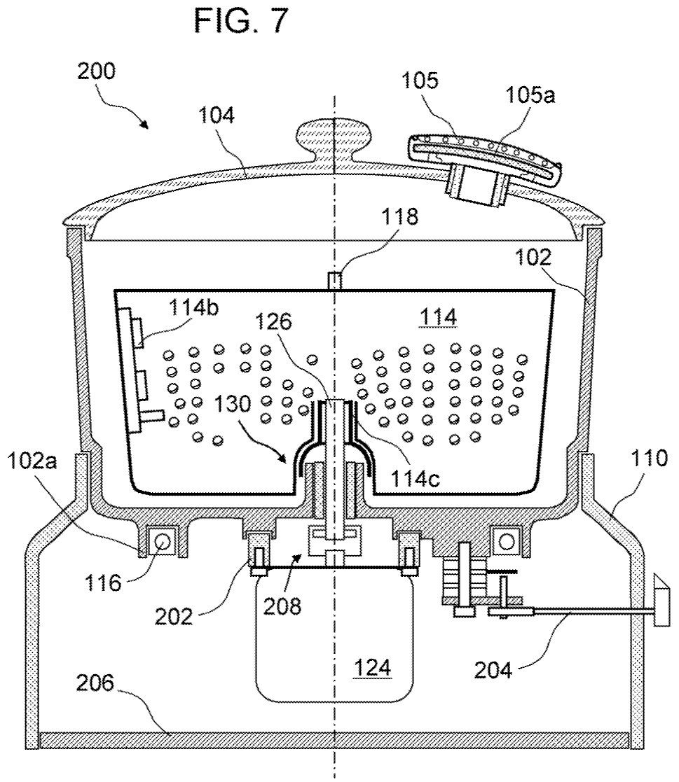

FIG. 7 illustrates a cross-sectional view of another embodiment of the present invention, a deep frying apparatus 200. Some components or devices of deep frying apparatus 200 are similar to those of deep frying apparatus 100. Similarity is in the sense of both functionality and configuration. Therefore, similar components or devices are denoted with similar reference numbers to avoid repetitive explanations. Deep frying apparatus 200 is a further simplified version of deep frying apparatus 100.

Motor 124 is installed on the bottom of container 102. A plurality of insulation block 202 of low thermal conductivity is provided in between motor 124 and the bottom of container 102 for shielding motor 124 away from heat transferred from the bottom of container 102. An adjustable thermostat 204, installed directly on the bottom of container 102, is provided for controlling the temperature of heating tube 116. A bottom cap 206 is provided for closing up the open bottom of support member 110.

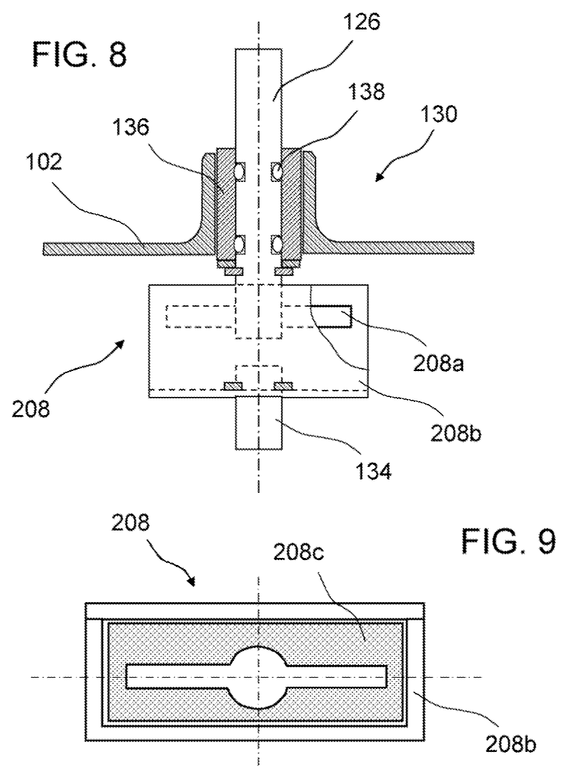

Reference is made to FIG. 8, which illustrates a side view of a coupling device 208 in FIG. 7. Coupling device 208 is provided for coupling motor 124 and drive shaft 126. Coupling device 208 includes an upper coupling element 208a, which is engaged with drive shaft 126, and a lower coupling element 208b, which is engaged with motor shaft 134. An insulation insert 208c of low thermal conductivity, as more clearly shown in FIG. 9, which illustrates a top view of coupling device 208, is provided in between coupling elements 208a and 208b, such that heat transferred from drive shaft 126 is prevented from passing through to motor 124, and whereby motor 124 is not overheated with the heat transferred from the bottom of container 102.

Accordingly, readers will see that this deep-frying apparatus of the present invention is highly compact to save kitchen space and manufacturing cost. The container is removable from the base support, such that it is convenient for cleaning after use and dishwasher safe. The support member adapts the container to stand directly on counter tops or dinning tables without the risk of overheating the same. The deep-frying apparatus can have secondary uses, such as boiling, steaming food, etc.

The present invention has been described in an illustrative manner. It is to be understood that the terminology, which has been used, is intended to be in the nature of words of description rather than of limitation.

Although this invention has been described in its preferred forms and structures with a certain degree of particularity, these should not be construed as limiting the scope of the invention but as merely providing illustrations of some of the presently preferred embodiments of this invention.

Thus it is understood that the present disclosure of the preferred forms can be changed in the details of construction and in the combination and arrangement of parts without departing from the spirit and the scope of the invention as hereinafter claimed.

What is claimed is:

1. A deep frying apparatus said deep frying apparatus comprising:
a container having an open top and a sidewall for holding food;
a lid for closing up the open top of said container;
a perforated basket rotatably installed inside said container for holding and rotating food;
heating means for heating food disposed inside said container;
wherein said heating means is installed on the bottom of said container;
a motor installed on the bottom of said container for driving said perforated basket;
wherein said motor is coupled with a drive shaft and said drive shaft is coupled with said perforated basket;
a support member having two ends for supporting said container; and
wherein the upper end of said support member is fixedly engaged with the periphery of the lower portion of said container and the lower end of said support member extends downward to a predetermined distance, such that said deep frying apparatus is adapted to stand on a horizontal surface.

2. A deep frying apparatus as defined in claim 1, wherein said heating means includes a heating tube of a circular configuration, said heating tube is fixedly installed inside a groove formed on the bottom of said container, and said heating tube is disposed close to the periphery of the bottom of said container with a predetermined distance.

3. A deep frying apparatus as defined in claim 1, wherein said perforated basket includes a shaft coupling element installed on the bottom of said perforated basket for removably receiving said drive shaft and a handle coupling element installed on the side of said perforated basket for removably receiving a basket handle for use of handling said perforated basket.

4. A deep frying apparatus as defined in claim 1, wherein said container includes a seat device for seating off the interface between said drive shaft and a central aperture on the bottom of said container, said seal device includes a bushing member fixedly and sealingly engaged with said central aperture on the bottom of said container, said drive shaft is threaded through said bushing member, and at least one packing member is adapted to be squeezed against said drive shaft and said bushing member for sealing off the interface thereof.

5. A deep frying apparatus as defined in claim 1, wherein said container includes at least one co-rotation prevention member installed on the sidewall of said container for preventing oil from co-rotation with said perforated basket, as said perforated basket rotates wherein said at least one co-rotation prevention member is extended generally vertical along the sidewall of said container, is generally rib-shaped, is extended from the lower portion of said container upward to the upper portion of said container, and is extended inward from the sidewall of said container to a predetermined distance, away from the sidewall of said container, and wherein a favorable oil flow is generated for facilitating heat transfer, as said perforated basket rotates.

6. A deep frying apparatus as defined in claim 1, said deep frying apparatus further including a venting device installed on said lid for exhausting cooking fumes and wherein said venting device includes filter means for cooking fume treatment.

7. A deep frying apparatus as defined in claim 1, said deep frying apparatus further including a thermostat installed on the bottom of said container for detecting and limiting the temperature of said heating means, such that said heating means and the neighboring components are not overheated and said deep frying apparatus is adapted for multiple applications of various temperature settings.

8. A deep frying apparatus as defined in claim 1, wherein said motor is coupled with said drive shaft through a coupling device, and said coupling device includes a insulation block for insulating said motor from heat, such that heat transferred from said drive shaft is prevented from passing through to said motor, and whereby said motor is not overheated with the heat transferred from the bottom of said container.

9. A deep frying apparatus as defined in claim 1, wherein said motor is fixedly engaged with a insulation member, said insulation member is fixedly installed on the bottom of said container, such that heat transferred from the bottom of said container is prevented from passing through to said motor, and whereby said motor is not overheated with the heat transferred from the bottom of said container.

10. A deep frying apparatus, said deep frying apparatus comprising:
a container having an open top and a sidewall for holding food;
a lid for closing up the open top of said container;
a perforated basket rotatably installed inside said container for holding and rotating food;
heating means for heating food disposed inside said container;
wherein said heating means is installed on the bottom of said container;
a base support disposed underneath said container for supporting said container;
a motor installed inside said base support for driving said perforated basket;
wherein said motor is removably coupled with a drive shaft and said drive shaft is coupled with said perforated basket;
a support member having two ends for supporting said container;
wherein the upper end of said support member is fixedly engaged with the periphery of the lower portion of said container and the lower end of said support member extends downward to a predetermined distance, such that said container is adapted to stand on said base support;
wherein said motor is coupled with said perforated basket as said container is disposed in position on said base support;
wherein said heating means is connected with an electrical port on said base support as said container is disposed in position on said base support;
wherein said container together with said support member is removable from said base support; and
whereby said container is convenient for cleaning after use and dishwasher safe.

11. A deep frying apparatus as defined in claim 10, wherein said heating means includes a heating tube of a circular configuration, said heating tube is fixedly installed inside a groove formed on the bottom of said container, and said heating tube is disposed close to the periphery of the bottom of said container with a predetermined distance.

12. A deep frying apparatus as defined in claim 10, wherein said perforated basket includes a shaft coupling element installed on the bottom of said perforated basket for removably receiving said drive shaft and a handle coupling element installed on the side of said perforated basket for removably receiving a basket handle for use of handling said perforated basket.

13. A deep frying apparatus as defined in claim 10, wherein said container includes a seal device for sealing off the interface between said drive shaft and a central aperture on the bottom of said container, said seal device includes a bushing member fixedly and sealingly engaged with said central aperture on the bottom of said container, said drive shaft is threaded through said bushing member, and at least one packing member is adapted to be squeezed against said drive shaft and said bushing member for sealing off the interface thereof.

14. A deep frying apparatus as defined in claim 10, wherein said container includes at least one co-rotation prevention member installed on the sidewall of said container for preventing oil from co-rotation with said perforated basket, as said perforated basket rotates, wherein said at least one co-rotation prevention member is extended generally vertical along the sidewall of said container, is generally rib-shaped, is extended from the lower portion of said container upward to the upper portion of said container, and is extended inward from the sidewall of said container to a predetermined distance, away from the sidewall of said container, and wherein a favorable oil flow is generated for facilitating heat transfer, as said perforated basket rotates.

15. A deep frying apparatus as defined in claim 10, said deep frying apparatus cooking fumes and wherein said venting device includes filter means for cooking fume treatment.

16. A deep frying apparatus as defined in claim 10, said deep frying apparatus further including a thermostat installed inside said base support for detecting and limiting the temperature of said heating means, such that said heating means and the neighboring components are not overheated and said deep frying apparatus is adapted for multiple applications of various temperature settings.

17. A deep frying apparatus as defined in claim 16, wherein said thermostat is preloaded with a spring member, the upper end of said thermostat protrudes upward above the upper surface of said base support, and when said container is disposed in position on said base support said thermostat is adapted to be engaged with the bottom of said container.

18. A deep frying apparatus as defined in claim 16, wherein said thermostat is preloaded with a spring member, a thermo plate is fixedly installed on the bottom of said container at a location substantially close to said heating means, the upper end of said thermostat protrudes upward above the upper surface of said base support, and when said container is disposed in position on said base support said thermostat is adapted to be engaged with said thermo plate.

19. A deep frying apparatus as defined in claim 10, wherein said support member includes at least one position guide for guiding said container in position on said base support, said base support includes at least one base guide for removably receiving said at least one position guide from said support member, such that said container is guided in position on said base support.

20. A deep frying apparatus as defined in claim 10, wherein said support member has a generally tapered hollow cylindrical configuration, the upper end of said support member is routed over the lower portion of said container and is fixedly engaged thereof, the lower end of said support member is routed over the upper portion of said base support and is removably engaged thereof, and the upper portion of said base support removably receives the lower end of said support member.
